(19) United States
(12) Patent Application Publication
(10) Pub. No.: US 2026/0336419 A1
(43) Pub. Date: Oct. 29, 2026

(54) WORK VEHICLE HAVING A SOFTWARE BASED HIGH VOLTAGE INTERLOCK

(71) Applicant: Deere & Company, Moline, IL (US)

(72) Inventors: Joe E. LUKASZEWSKI, Dubuque, IA (US); Christopher L. Marohl, Fargo, ND (US); JACOB R. DECOCK, Fargo, ND (US)

(21) Appl. No.: 19/190,913

(22) Filed: Apr. 28, 2025

(51) Int. Cl. B60L 3/04; B60L 1/00; B60L 3/00; B60L 3/12

(52) U.S. Cl. CPC B60L 3/04; B60L 1/003; B60L 3/0061; B60L 3/0084; B60L 3/12; B60L 2200/40

(57) ABSTRACT

A work vehicle with a high voltage interlock system can include a high and each of a plurality of load devices. The high voltage source has a high voltage current output and a switch operable to disconnect the conductor from the high voltage current output. The high voltage source and each of the plurality of load devices includes a detector configured to sense a local power state produced by the coupled high voltage conductor. A controller in the work vehicle can be coupled to each of the load devices and the high voltage source via a signal line and can be configured to receive data signals responsive to the local power state sensed by each detector and to transmit a command signal to the switch to disconnect the conductor from the high voltage current output based on the received data signals.

### FIELD OF THE DISCLOSURE

The present disclosure relates generally to work vehicles that use a high voltage electrical source to power high voltage loads and, more specifically, to a software based high-voltage interlock system in such work vehicles.

### BACKGROUND

Some work vehicles, such as tractors, backhoe loaders, and skid steers, use high-voltage power sources to drive high voltage loads such as electrically powered traction drives and implements. These high-voltage systems often utilize a high-voltage interlock (HVIL) as one means of providing a safeguard against a short or inadvertent open (e.g., an exposed conductor) high-voltage circuit that may present a risk of shock or damage to drivers, passengers, components of vehicle, and/or other persons or components that may come into contact with a portion of vehicle that becomes inadvertently charged by a high-voltage source. For example, such vehicles generally use dedicated high voltage conductors with end connectors that are used to interconnect high voltage power sources to high voltage loads driven to transmit the high voltage currents used to drive the high voltage loads. Due to operational vibrations, improper connection, or damage, one or more connectors may become loose, fail to make a proper connection, or expose high voltage conductors to contact with people or surfaces that should remain isolated from high voltage. This can present a hazard as high voltage loads may not function properly, exposed conductors present a risk due to shock, fire, overvoltage, etc. to persons and/or property.

FIG. 1 is one example of a prior art power distribution system 100 with an HVIL system and includes a high voltage loop having a high-voltage (HV) source 102 that provides power to high-voltage (HV) load 104 through high-voltage (HV) conductor 106. HV conductor 106 may be a single conductor that utilizes a conductive metal chassis or other conductive member as an electrical ground to complete the circuit or, alternatively, may be a dual conductor, with separate insulated conductors for power supply and return. An HVIL provides a low-voltage (LV) circuit that is designed to detect breaks in the high-voltage connection between the HV sources and HV loads in the vehicle when end connectors on the conductor become loose or completely disconnected from their sockets. Signal generator 110 transmits a low voltage signal to signal detector 112 on LV conductor 126. LV conductor 126 is routed through short circuit connections in HV end-connectors 108, 116 that connect HV conductor 106 to HV source 102 and HV load 104. LV conductor 126 is also routed separately from HV conductor 106 on a low voltage line with end-connectors 118, 120 between HV source 102 and HV load 104. A communications network including a signal line 124 with end-connectors 122, 126 provide a third, separate connection from the HV conductor 106 and LV conductor 126, between HV source 102 and HV load 104. Signal line 124 transmits data and commands between sensors and control circuits in HV source 102 and HV load 104, and electronic control module (ECM) 114 which monitors and controls the operation of power distribution system 100. If HV end-connectors 108, 116 fail to make a proper connection and thereby present a risk that a break may occur in the high voltage connection of HV conductor 106 between HV source 102 and HV load 104, the HVIL's LV circuit is immediately severed because the short circuits in HV end-connectors 108, 116 are not all complete. When HVIL detector 112 fails to detect the low voltage signal from HVIL generator 110 it disconnects the output of HV source 102 from HV conductor 106. Generally for safety, if HV end-connectors 108, 116 loosen or become damaged, the short circuits are designed to fail before actual disconnection of HV conductor 106 from HV source 102 or HV load 104.

Despite the advantages of prior art HVILs, their components can be subject to damage or degradation and may fail. A failed HVIL may falsely indicate a fault in the high-voltage circuit, even though the high-voltage circuit itself is intact and fault-free. For example, if any end-connectors 118, 120 of LV conductor 126 loosen or become damaged, HVIL detector 112 may fail to detect the low voltage signal from HVIL generator 110 and disconnect the output of HV source 102 from HV load 104. Thus, a failure of an HVIL component may needlessly cause the disconnection of the work vehicle from its power supply and disable vehicle 100 even through a proper HV connection is maintained of end-connectors HV end-connectors 108, 116 to HV source 102 and HV load 104. Sudden and unexpected loss of power may strand the work vehicle and subject vehicle, driver and payloads to undue hazards. Therefore, a need exists for work vehicles with high voltage power distribution systems with high voltage interlock systems that avoid false faults due to unnecessary components of the HVIL system.

### SUMMARY OF THE DISCLOSURE

In one embodiment, a work vehicle with a high voltage interlock system includes a high voltage loop with a high voltage conductor coupled between a high voltage source and each of a plurality of load devices. The high voltage source has a high voltage current output and a switch operable to disconnect the conductor from the high voltage current output. The high voltage source and each of the plurality of load devices includes a detector configured to sense a local power state produced by the coupled high voltage conductor. At least one of the load devices is an electric machine coupled to drive a ground engaging unit. The work vehicle includes a controller coupled to each of the load devices and the high voltage source via a signal line. The controller is configured to receive data signals responsive to the local power state sensed by each detector via the signal line and configured to transmit a command signal to the switch to disconnect the conductor from the high voltage current output based on the received data signals.

According to one aspect, the work vehicle can also include a low voltage injection source having a low voltage current output electrically coupled to the high voltage conductor. Optionally, the controller can be configured to receive data signals responsive to the local power state sensed by each detector via the signal line whenever the switch disconnects the conductor from the high voltage current output. In addition, under this option, the controller can be configured to transmit a command signal to the switch to connect the conductor to the high voltage current output if the local power state sensed by each detector of the plurality of load devices senses the low voltage current output. According to another aspect, the work vehicle's electric drive motor can be coupled to drive a hydraulic pump and, optionally, the hydraulic pump can be hydraulically coupled to a hydraulic actuator.

In some embodiments, the local power state can be a local voltage and the controller can be configured to disconnect the conductor when the difference between the local voltage in a load device and the local voltage in the high voltage source exceeds a threshold value. Alternatively, the controller can be configured to disconnect the conductor whenever the controller fails to receive the data signal.

In a second embodiment, a work vehicle can have a drivetrain mounted on a frame. The drivetrain can include a plurality of ground engaging units for supporting the frame from a ground surface. At least one of the ground engaging units can be rotatably coupled to an electric machine, the electric machine configured to propel the work vehicle along the ground surface. The work vehicle can also include an electric drive motor mechanically coupled to drive a hydraulic pump, a hydraulic actuator fluidly coupled to the hydraulic pump, and a high voltage loop that includes a high voltage conductor coupled between a high voltage current output of a high voltage source, the electric drive motor, and the electric machine. The high voltage source can have a switch operable to disconnect the conductor from the high voltage current output. Also, the high voltage source, and at least one of the electric drive motor and the electric machine, can include a detector configured to sense a local power state produced by the coupled high voltage conductor. The work vehicle can further include a controller coupled to each of the load devices and the high voltage source via a signal line, the controller configured to receive data signals responsive to the local power state sensed by each detector via the signal line and configured to transmit a command signal to the switch to disconnect the conductor from the high voltage current output based on the received data signals.

According to one aspect, the work vehicle can include a low voltage injection source having a low voltage current output electrically coupled to the high voltage conductor. Optionally, according to this aspect, the controller can be configured to receive data signals responsive to the local power state sensed by each detector via the signal line whenever the switch disconnects the conductor from the high voltage current output. In addition, the controller can be configured to transmit a command signal to the switch to connect the conductor to the high voltage current output if the local power state sensed by each detector of the plurality of load devices senses the low voltage current output.

According to another aspect, the local power state can be a local voltage and the controller can be configured to disconnect the conductor when the difference between the local voltage in a load device and the local voltage in the high voltage source exceeds a threshold value. In embodiments where the work vehicle includes a low voltage injection source and the local power state is a local voltage, the controller can be configured to disconnect the conductor when a difference between the local voltage in a load device and the local voltage in the high voltage source or in the low voltage injection source exceeds a corresponding high voltage or low voltage threshold value.

According to an alternative aspect, the controller can be configured to disconnect the conductor whenever the controller fails to receive the data signal.

### BRIEF DESCRIPTION OF THE DRAWINGS

FIG. 1 is a schematic diagram of a prior art power distribution system with a high voltage interlock loop circuit.

FIG. 2 is a side view of one embodiment of a work vehicle.

FIG. 3 is a schematic diagram of one embodiment a power distribution system the work vehicle of FIG. 2.

FIG. 4 is a schematic diagram of one embodiment of an high voltage interlock loop circuit of the work vehicle of FIG. 2.

### DETAILED DESCRIPTION

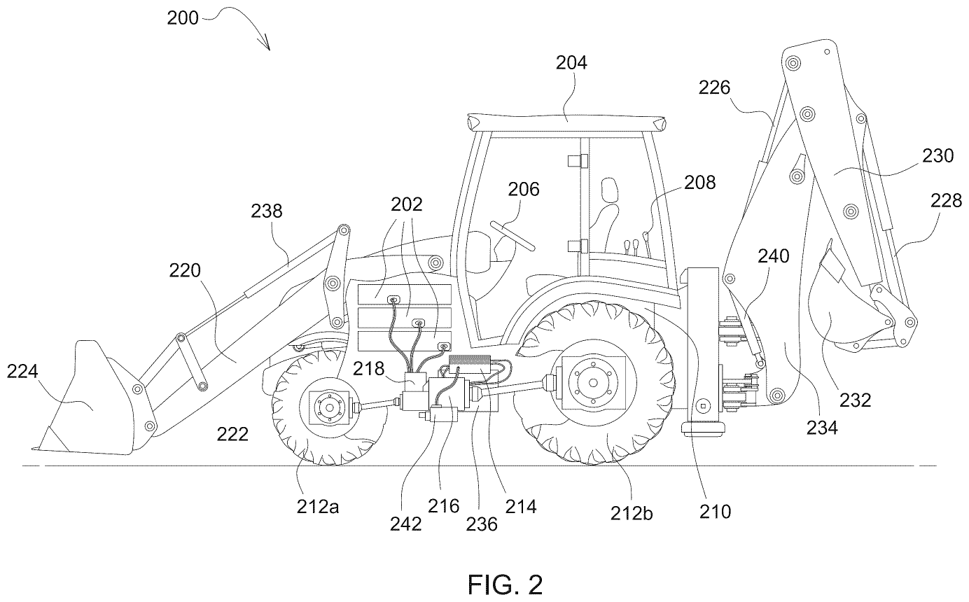

In one embodiment shown in FIG. 2, a work vehicle 200 can be a backhoe loader which uses a high voltage electrical source 202 to at least partially power high voltage loads such as electric motors of a traction drive or of a hydraulic system's pumps. The high voltage source 202 can be an energy storage device, such as a set of one or more batteries, capacitors, or a flywheel energy storage system. Alternatively, the high voltage source can be an electrical generator that convert mechanical or thermal energy into high voltage electrical power, or an external source of electrical power. Generally, such a high voltage source outputs electrical power at above about 60V DC. Generally, low voltage source outputs are limited to 60V or less. Work vehicle 200 can include a frame 210 which provides a structure to support various components of work vehicle 200. Work vehicle 200 can also include a chassis. The chassis can include frame 210 as well as other structural members or panels that are rigidly or fixedly attached to one another to form an integral body that can resist an applied weight or force. One set of components can form a drivetrain with a traction drive attached to the frame and configured to propel work vehicle 200 and its frame 210 along a ground surface. The drivetrain can also be coupled to drive pumps of a hydraulic system on the frame. The hydraulic system can include hydraulic actuators and/or hydraulic motors that rotate, extend, or retract to move or power work tools or work implements on the vehicle. The work tools or work implements can thus be movably attached to the frame. Other components attached to frame 210 can include a control system that receives operator commands through joysticks 208, pedals, steering wheels 206, switches, and levers on consoles and control panels in operator cab 204 and operates work vehicle 200 in response to the received commands. Further components attached to frame 210 can include an accessory system with heating and cooling devices, such as fans, air conditioning compressors, and heaters to maintain a comfortable environment for an operator in cab 204. The accessory system can also include guidance systems that assist an operator to navigate the working vehicle to an around a work site.

Frame 210 of work vehicle 200 can be supported above a ground surface by ground engaging units which can be a pair of front wheels 212a and a pair of rear wheels 212b. The front wheels 212a and rear wheels 212b can be mounted onto frame 210 via wheel hubs which can be driven to rotate by one or more hydraulic or electrical motors coupled to the hubs. The wheel hubs and motors form part of the traction drive of the drivetrain. The drivetrain further includes a battery pack mounted towards the front of frame 210. The battery pack is a high voltage source 202 which is electrically coupled to power electric machine 216. Electric machine 216 can operate as a traction drive motor to drive wheels 212a, 212b when configured to receive electrical power from high voltage source 202. Conversely, electric machine 216 can act as a generator that replenishes high voltage source 202 when the momentum of work vehicle 200 along the ground surface rotates wheels 212a, 212b and drives electric machine 216. High voltage source 202 can also be configured to power an electric motor which is mechanically coupled to drive hydraulic pump 242. When driven, hydraulic pump 242 supplies high pressure hydraulic fluid through a pump outlet and hydraulic lines to actuators, such as hydraulic cylinders 222, 226, 228. In cases where high voltage source 202 includes a battery pack, battery management system (BMS) 218 can monitor the voltage, current and temperature, ensure performance and safety, and balance charging, state of charge, state of health and functionality of the battery modules in the battery pack. BMS 218 can also include a controller which can connect or disconnect the battery pack from high voltage loads and/or other high voltage sources in work vehicle 200. BMS 218 can supply high voltage DC electrical power from the battery pack to inverter 214 to convert high voltage DC to alternating current (AC) electrical power suitable for electric machine 216. Inverter 214 can also supply AC electrical power to the electric motor that is coupled to and drive hydraulic pump 242. Controller 236 can be an electrification domain controller configured to control the routing of power to and from a high voltage supply and to regulate the operation of the high voltage load components of the drivetrain and accessories. In some embodiments, controller 236 can include a processor and memory and/or programmable electronic circuits.

Work vehicle 200 can include implements such as front bucket 224 and rear bucket 232. As those skilled in the art will appreciate, although front bucket 224 and rear bucket 232 are not powered, these buckets can be replaced with different types of implements, including those that are powered such as hydraulic hammers, hydraulic augers, and hydraulic scarifiers or milling machines. Front bucket 224 is pivotably coupled to boom 220 which, itself, is pivotably attached to frame 210. Hydraulic cylinder 222 is coupled between boom 220 and frame 210 to raise boom 220 and attached front bucket 224 when actuated to extend and to lower boom 220 when actuated to retract. Hydraulic cylinder 238 is coupled through mechanical linkages between front bucket 224 and boom 220 and can be actuated to extend and rotate front bucket 224 forwards or retract to rotate front bucket 224 backwards. Rear bucket 232 is coupled frame 210 via stick 230 and rear boom 234. Rear boom 234 is pivotally coupled at its near end to frame 210 to permit its far end to pivot upwards or downwards when rear boom hydraulic cylinder 240 is retracted or extended. Rear boom hydraulic cylinder 240 is coupled between frame 210 and rear boom 234. Stick cylinder 226 is coupled between rear boom 234 and stick 230 and can be controlled to extend or retract to pivot stick 230 relative to rear boom 234. Rear bucket 232 is pivotally attached at one end of stick 230 and bucket cylinder 228, which is coupled between stick 230 and rear bucket 232, can be controlled to extend or retract to curl or open rear bucket 232. Controllers in work vehicle 200, such as a machine controller, can be communicatively coupled to actuate hydraulic valves that control the flow of pressurized hydraulic fluid to extend or retract hydraulic cylinders 222, 238, 226, 228, 240 in response to operator commands. The controllers can receive these operator commands through input devices such as joysticks or levers on consoles and control panels in operator cab 204. These controllers can also receive operator commands via the consols and control panels and operate the traction drive and accessories in response.

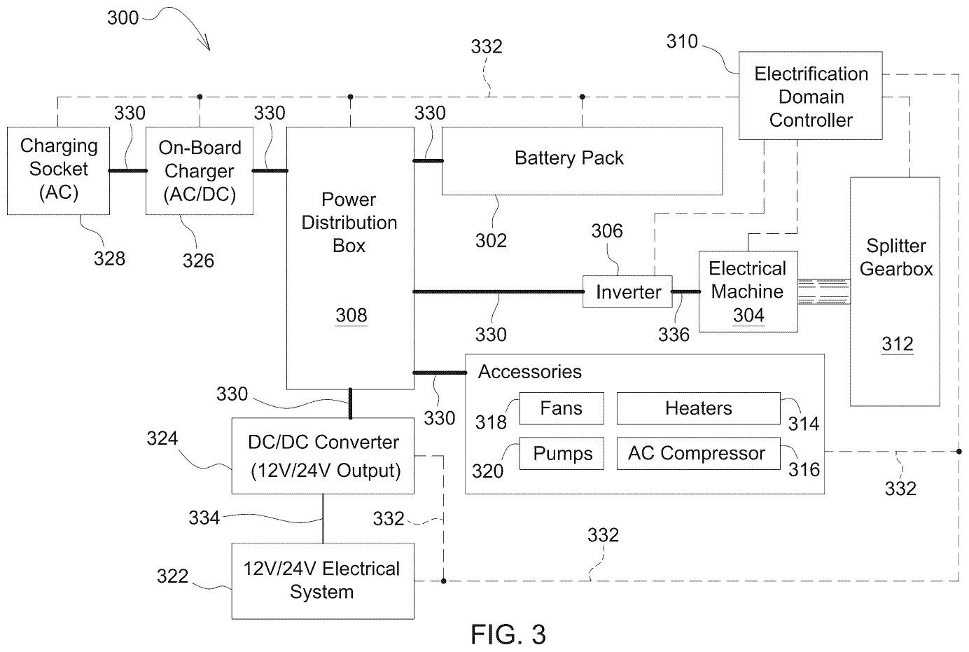

One embodiment of the electrical system of a drivetrain that can be implemented in work vehicle 200 is power distribution system 300 shown in FIG. 3. Power distribution system 300 includes an electrification domain controller 310 which is communicatively coupled to each component in the system by a communication or data network 332, shown in dashed lines. Domain controller 310 can include a processor and memory configured with code to monitor status and measurement signals it receives from each component and to transmit command signals to control the operation of each component of power distribution system 300. One high voltage source is charging socket 328 which can be connected to receive electrical power from an external high voltage AC supply such as an external charging station. High voltage conductor 330 shown in thick black line connects charging socket 328 to power distribution box 308 via on-board charger 326. On board charger 326 converts the high voltage AC supply to high voltage DC received by power distribution box 308. Battery pack 302 can include multiple individual battery modules with an integrated battery management system which controls battery pack 302 can be connected to the electrical system. A separate controller, such as electrification domain controller 310 can control whether battery pack 302 outputs power as a high voltage source or receives and stores power as a high voltage load. For example, electrification domain controller 310 can be configured to control battery pack 302 receive high voltage DC power from power distribution box 308 to control charging and storage of energy in battery modules of battery pack 302. Conversely, electrification domain controller 310 can control the discharge and supply of high voltage DC power from battery modules of battery pack 302 to power distribution box 308. The battery modules can comprise lithium-ion batteries that can output between 500 and 800 volts DC, for example. Preferably, the power distribution system is designed to work over a wide voltage range and accommodate changes in the output voltage of the battery pack 302 due to load or depth of discharge. However, generally the high voltage loads can be designed to operate at any voltage above 60V.

The power distribution box 308 connects and supplies electrical power from high voltage sources to high voltage loads and includes, among other things, fuses, wiring, and connectors for distributing the high voltage electrical power to various components of the work vehicle's traction drive system and accessories. As shown in FIG. 3, power distribution box is directly connected to all high DC voltage sources and high voltage loads by a high voltage conductor 330, while low voltage sources and loads are interconnected by a low voltage conductor 334 shown in a thin, solid line. The power distribution box 308 distributes the high voltage output from the battery pack 302 or from on-board charger 326 to inverter 306 which converts the high voltage DC power supply into the high voltage AC supply electric machine 304 requires. A separate high AC voltage conductor 336 connects the inverter's high voltage AC terminal to electric machine 304. Splitter gearbox 312 can include multiple selectable gears or can include a continuously variable transmission and can be configured to change gear ratios based on command signals from a controller. Alternatively, splitter gearbox 312 can have a fixed gear ratio, or can be designed to transmit power to multiple loads, such as hydraulic pumps, electric machines, and mechanical drives. Splitter gearbox 312 mechanically couples electric machine 304 to drive the ground engaging units based on the gear ratio of splitter gearbox 312. Electric machine 304 can be mechanically driven to generate high voltage electrical power transmitted to power distribution box 308. Power distribution box 308 also provides high voltage DC supply to DC/DC converter 324 which outputs a low voltage DC supply (for example at 12 volts or 24 volts) to the 12V/24V electrical system 322. The 12V/24V electrical system 322 can be configured to power the controllers, instrumentation, consoles, and control panels in work vehicle 200 that require low voltage electrical power to transmit and receive information and commands to the operator. Power distribution box 308 additionally provides high voltage DC supply to the radiators/fans 318 used to regulate battery pack and electric machine temperatures, pumps 320 driven by high voltage electric motors, such as the hydraulic pumps used to pressurize the work vehicle's hydraulic system, heaters 314 and air-conditioning compressors 316 used to regulate the temperature within operator cab 204.

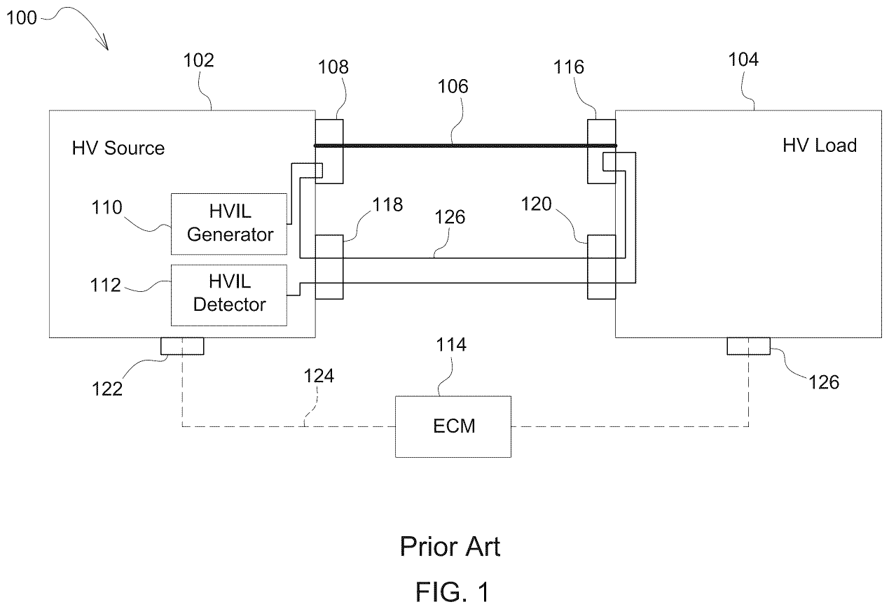

The high voltage conductor 330 electrically connects high voltage DC sources and high voltage DC load devices to form a high voltage loop. A high voltage interlock (HVIL) loop system controls the supply of high voltage electrical power to the high voltage loop when the HVIL system determines that the high voltage loop is properly connected and safely operable. The HVIL system terminates and prevents the supply of high voltage electrical power when it detects a fault or improper connection in the high voltage loop. As described with respect to FIG. 1's work vehicle's prior art power distribution systems, in conventional systems the function of the high voltage conductor depends on the integrity of a separate connection between the high voltage source and the high voltage load of the high voltage interlock loop (HVIL) circuit. A controller, such as a domain controller in such systems monitors the HVIL circuit for loss of continuity due to breaks in the HVIL circuit. A loss of continuity or isolation in the HVIL signals a fault and the controller immediately disconnects the high voltage source from the high voltage conductor to render the high voltage conductor and connected devices safe. However, the parallel low voltage conductor of the HVIL circuit can add significant cost and results in an increased frequency of false positives where the HVIL circuit signals a fault despite satisfactory continuity of the high voltage conductor. Accordingly, in one aspect the present embodiment includes an HVIL system that avoids the need for a separate low voltage HVIL circuit.

The high voltage interlock (HVIL) loop system of the present embodiment includes no low voltage conductors in parallel or co-located with high voltage conductor 330 of power distribution system 300. Instead, each high voltage source component and each high voltage load component or device can include a sensor or detector that monitors a local power state produced by the coupled high voltage conductor. The local power state of a high voltage source or high voltage load device can be any property measured in a device of an electrical current transmitted on or received from the high voltage conductor 330. Thus, the local power state can be a local voltage, or a local current measured in the high voltage source or load device that represents the voltage or current received or transmitted on the high voltage conductor 330. A controller in power distribution system 300 monitors the signals from the detectors or sensors received via communication or data network 332 to determine whether to disconnect the high voltage sources due to a detected loss of continuity in high voltage conductor 330.

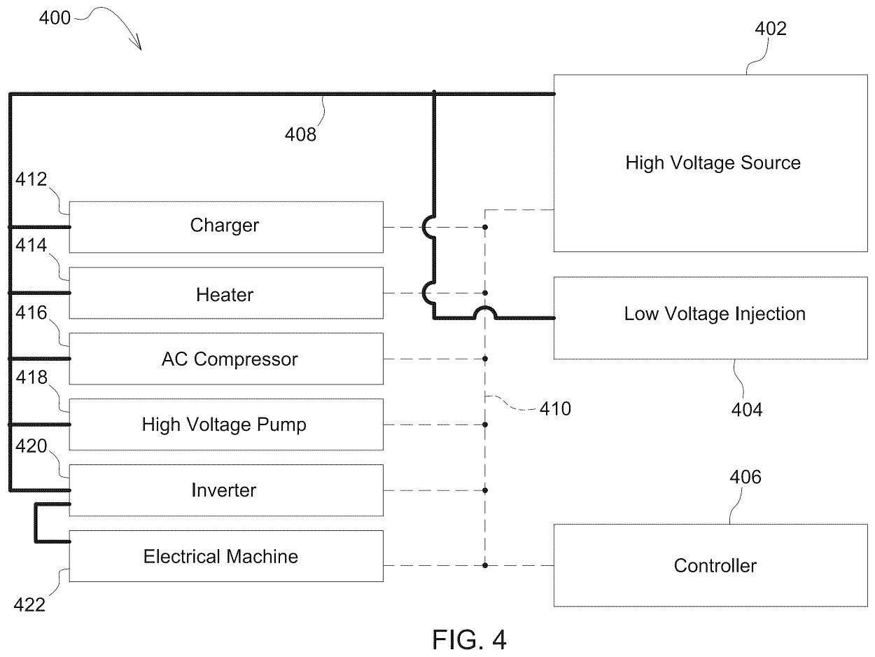

FIG. 4 shows an embodiment of a power distribution system 400 with an HVIL system suitable for work vehicle 200. High voltage source 402 supplies high voltage electrical power through a high voltage current output to high voltage loads via high voltage conductor 408. High voltage loads can include heater 414, air conditioner compressor 416, high voltage pump 418, inverter 420 and electric machine 420. Charger 412 can be an alternate high voltage source that receives high voltage alternating current from a charging station that is external to work vehicle 200 and can convert the high voltage alternating current into a high voltage direct current. Charger 412 can be configured to supply the high voltage direct current to the high voltage loads connected to high voltage conductor 408. In some embodiments, high voltage source 402 can be a battery pack with an integrated BMS. The electrification domain controller 310 can be configured to control the supply of high voltage power from battery modules in the battery pack to high voltage conductor 408, or to control the supply of high voltage power from high voltage conductor 408 to recharge the battery modules.

High voltage conductor 408 also connects to low voltage injection source 404 which is configured to supply low voltage DC power to high voltage conductor 408 when a fault is detected or when no high voltage source 402 is connected to high voltage conductor 408. The low voltage dc power of low voltage injection source 404 allows the HVIL system to monitor the integrity of high voltage conductor 408 connections to high voltage load devices while the high voltage source 402 is disconnected.

Controller 406 is connected to high voltage source, 402, charger 412, and each of the high voltage load devices via signal line 410 which forms a communication network. A detector or sensor in high voltage source 402 and in each high voltage load device can transmit a signal responsive to each detector's measurement of its local power state to controller 406 over the signal line 410. Controller 406 can also transmit commands to control the operation of high voltage source, 402, charger 412, and each of the high voltage loads via signal line 410. High voltage source 402 includes a high voltage isolation switch which can, optionally, be integrated into BMS. The high voltage isolation switch is configured to selectively connect and disconnect the high voltage current output of high voltage source 402 from high voltage conductor 408 in response to a command signal received from controller 406 via signal line 410 of the communication network. Charger 412 and the high voltage load devices can each include similar controller-operated high voltage isolation switch configured to selectively connect and disconnect each device from high voltage conductor 408 in response to a command signal received from controller 406 via signal line 410.

When controller 406 receives a command from an operator to operate a feature of work vehicle 200 that uses a high voltage load device when all high voltage sources are disconnected, controller 406 can monitor the data signals received from each sensor or detector regarding the local power state in each of the connected high voltage load devices. Controller 406 can compare the data signals to determine whether all high voltage load devices are uniformly receiving the output of low voltage injection source 404 to confirm the integrity of the interconnection of high voltage conductor 408. Once proper connection of high voltage conductor 408 to each high voltage load device is confirmed, controller 406 can transmit a command signal to high voltage source 402 to operate its high voltage isolation switch to connect its high voltage current output to high voltage conductor 408. Controller 406 can likewise send command signals to any high voltage load device or high voltage sources that include controller operable high voltage isolation switches to connect the device to the high voltage conductor 408. When high voltage conductor 408 connects high voltage current output of high voltage source 402 to high voltage load devices and or to charger 412, the sensor or detector in each of the connected host high voltage load devices and high voltage sources measures the local power state, i.e., the power state of the host high voltage source or load device, and transmits a data signal responsive to the sensed local power state on signal line 410. The local power state can be, for example, the voltage of the hose device or host power source at or near its connection with high voltage conductor 408, or the current received or transmitted on high voltage conductor 408.

Controller 406 is configured to receive each of the local power state data signals transmitted by each of the host devices and each of the host sources to monitor and detect the presence of faults in the power distribution system 400. The power distribution system's HVIL system includes the detectors and isolation switches in each of the host devices and each of the host sources as well as the signal line 410 of the communication network, and controller 406. These HVIL system components interact to isolate dangerous high voltages produced by high voltage sources whenever the HVIL detects faults.

According to one example, the data signal that controller 406 receives from each detector is a local power state representing the local voltage the detector measures. Controller 406 compares each local voltage with the measured voltage at the high voltage current output of high voltage source 402. The difference between the local voltage of a detector and the voltage of the high current output is the voltage drop across the high voltage conductor and all the intermediate connections between the high voltage source and the host high voltage load device or charger 412 in which the detector is located. If the difference between the local voltage of any detector and voltage at the high voltage current output exceeds a threshold value, controller 406 determines that a fault exists. The fault may be due to an improper connection or a break in the high voltage conductor 408. Accordingly in response, controller 406 transmits a command signal to operate the isolation switch in high voltage source 402 to disconnect high voltage current output from the high voltage conductor 408. With the high voltage current output disconnected from high voltage conductor 408, low voltage injection source 404, supplies a safe, low voltage current to the high voltage load devices connected to high voltage conductor 408. As a further option, controller 406 can transmit a command signal to operate the isolation switch in the high voltage load device that hosts the detector producing the fault signal to immediately disconnect the suspected faulty high voltage load device from the low voltage current. In emergencies, completely isolating the suspected faulty high voltage load device from all power may be preferable to avoid imminent catastrophic failure.

In an alternative embodiment, each detector can measure the current flowing between high voltage conductor 408 and the host device or source and can transmit a data signal responsive to the measured current to controller 406. Controller 406 can compare each detector's current measurements with a reference value expected for the host load device or source. The expected reference value can be determined or adjusted based on the performance or work output of the host device. For example, where the load device is electric machine 422 coupled to drive the work vehicle's traction drive, expected reference value for the current can be estimated based on the estimated power output of the work machine. Controller 406 can also compare each detector's current measurement with the current measurement of the other detectors. If controller 406 determines that a detector's current measurements are too high or too low, either compared to the expected reference or compared to the measurements of other detectors, this may indicate a fault in the host device or the high voltage source 402. For example, excessively high current may indicate an electrical short, loss of insulation, or other malfunction in the host device. Abnormally low current may indicate a poor connection between the high voltage source 402 and the load device. A significant difference between the current output by the high voltage source 402 and the total current received by all the connected load devices, may indicate a short or loss of insulation in high voltage conductor 408. In each of these fault scenarios, controller 406 can transmit a command signal to the isolation switch in high voltage source 402 and, optionally, to isolation switches in charger 412 and/or to load devices to disconnect from high voltage connector 408.

In a further alternative embodiment, controller 406 can transmit a command signal to each high voltage source and to each high load device requesting each detector and/or switch transmit a data signal on signal line 410 to confirm proper operation of each switch and detector. If controller 406 fails to receive a data signal from each detector and/or switch, this indicates a failure in the high voltage loop. In response, controller 406 can control the switches in each high voltage source to disconnect the high voltage current output from high voltage conductor 408 to eliminate all dangerous high voltages in the high voltage loop.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A work vehicle (200) having a high voltage interlock system comprising:
a high voltage loop that includes a high voltage conductor (408) coupled between a high voltage source (402) and each of a plurality of load devices, the high voltage source (402) having a high voltage current output and a switch operable to disconnect the conductor from the high voltage current output, wherein the high voltage source (402) and each of the plurality of load devices includes a detector configured to sense a local power state produced by the coupled high voltage conductor (408), and wherein at least one of the load devices is an electric machine (422) coupled to drive a ground engaging unit;
a controller (406) coupled to each of the load devices and the high voltage source (402) via a signal line (410), the controller (406) configured to receive data signals responsive to the local power state sensed by each detector via the signal line (410) and configured to transmit a command signal to the switch to disconnect the conductor from the high voltage current output based on the received data signals.

2. The work vehicle (200) of claim 1, further comprising a low voltage injection source (404) having a low voltage current output electrically coupled to the high voltage conductor (408).

3. The work vehicle (200) of claim 2, wherein the controller (406) is configured to receive data signals responsive to the local power state sensed by each detector via the signal line (410) whenever the switch disconnects the conductor from the high voltage current output and configured to transmit a command signal to the switch to connect the conductor to the high voltage current output if the local power state sensed by each detector of the plurality of load devices senses the low voltage current output.

4. The work vehicle (200) of claim 1, wherein at least one of the load devices is an electric drive motor coupled to drive a hydraulic pump (242).

5. The work vehicle (200) of claim 4, wherein the hydraulic pump (242) is hydraulically coupled to a hydraulic actuator.

6. The work vehicle (200) of claim 1, wherein the local power state is a local voltage or a local current.

7. The work vehicle (200) of claim 6, wherein the controller (406) is configured to disconnect the conductor when a difference between the local voltage in a load device and the local voltage in the high voltage source (402) exceeds a threshold value.

8. The work vehicle (200) of claim 1, wherein the controller (406) is configured to disconnect the conductor whenever the controller (406) fails to receive the data signal.

9. A work vehicle (200) comprising:
a drivetrain mounted on a frame (210), the drivetrain including a plurality of ground engaging units for supporting the frame (210) from a ground surface, at least one of the ground engaging units being rotatably coupled to an electric machine (422), the electric machine (422) configured to propel the work vehicle (200) along the ground surface;
an electric drive motor mechanically coupled to drive a hydraulic pump (242);
a hydraulic actuator fluidly coupled to the hydraulic pump (242);
a high voltage loop that includes a high voltage conductor (408) coupled between a high voltage current output of a high voltage source (402), and load devices including at least the electric drive motor, and the electric machine (422), the high voltage source (402) having and a switch operable to disconnect the conductor from the high voltage current output, wherein the high voltage source (402) and at least one of the electric drive motor and the electric machine (422) include a detector configured to sense a local power state produced by the coupled high voltage conductor (408),
a controller (406) coupled to each of the load devices and the high voltage source (402) via a signal line (410), the controller (406) configured to receive data signals responsive to the local power state sensed by each detector via the signal line (410) and configured to transmit a command signal to the switch to disconnect the conductor from the high voltage current output based on the received data signals.

10. The work vehicle (200) of claim 9, further comprising a low voltage injection source (404) having a low voltage current output electrically coupled to the high voltage conductor (408).

11. The work vehicle (200) of claim 10, wherein the controller (406) is configured to receive data signals responsive to the local power state sensed by each detector via the signal line (410) whenever the switch disconnects the conductor from the high voltage current output and configured to transmit a command signal to the switch to connect the conductor to the high voltage current output if the local power state sensed by each detector of the plurality of load devices senses the low voltage current output.

12. The work vehicle (200) of claim 9, wherein the local power state is a local voltage or a local current.

13. The work vehicle (200) of claim 12, wherein the controller (406) is configured to disconnect the conductor when a difference between the local voltage in a load device and the local voltage in the high voltage source (402) exceeds a threshold value.

14. The work vehicle (200) of claim 10, wherein the local power state is a local voltage and the controller (406) is configured to disconnect the conductor when a difference between the local voltage in a load device and the local voltage in the high voltage source (402) or in the low voltage injection source (404) exceeds a corresponding high voltage or low voltage threshold value.

15. The work vehicle (200) of claim 9, wherein the controller (406) is configured to disconnect the conductor whenever the controller (406) fails to receive the data signal.
